(19) United States
(12) Patent Application Publication
(10) Pub. No.: US 2006/0222085 A1
(43) Pub. Date: Oct. 5, 2006

(54) System(s), methods(s), and apparatus for extracting slices from bitstream

(76) Inventor: Chhavi Kishore, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/095,371

(22) Filed: Mar. 30, 2005

(51) Int. Cl. H04B 14/04

(52) U.S. Cl. 375/253

(57) ABSTRACT

Presented herein are video system(s), method(s), and apparatus for extracting slice groups from data words. According to one embodiment, there is presented a circuit for extracting a data structure from one or more data words. The circuit comprises a multiplexer, a barrel shifter, another multiplexer, and a bit pointer. The multiplexer divides the one or more data words into a plurality of smaller data words. The barrel shifter shiftings the smaller data words. The other multiplexer provides one or more bits from one or more of the smaller data words. The bit pointer points to a bit following the provided one or more bits in the one or more of the smaller data words.

### RELATED APPLICATIONS

This application is related to “System, Method, and Apparatus for Slice End Detection Logic”, Ser. No. ______, Attorney Docket No. 15942US01, by Kishore, filed ______.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Video compression standards use a variety of techniques to compress video data. The techniques include both lossy and lossless compression. The lossy compression typically takes advantage of spatial and temporal redundancies in the video data.

In a number of standards, such as MPEG-2, and Advanced Video Coding (AVC) (also known as the ITU-H.264 Specification, and MPEG-4, Part 10), pictures from the video data are divided into blocks. Reference frames are examined for similar blocks, and the blocks of a picture are coded as the difference between themselves and a similar block in the reference picture (known as the prediction error). Blocks from an area are grouped together forming what is known as a macroblock. The macroblocks are grouped together into groups forming what is known as a slice.

Generally, the slices are encoded using lossless coding, and the coding of symbols within a slice are dependent on other symbols of the slice. Although error detecting and correcting codes are used, enough errors in a slice can render the slice irrecoverable.

A picture includes a number of slice groups, each of which are lossless coded independent of each other. Accordingly, in the event that a burst error renders one slice irrecoverable, the remaining slice groups of the picture can be decoded. This can even perceptually mask the burst error to the viewer.

Decoders typically include buffers for storing received a bitstream transmitting encoded video data. The buffer stores the bitstream as datawords. The datawords can vary in length, but there are advantages in storing the bitstream in wide datawords, such as 256-bit/32-byte words, known as Jumbo words (Jwords).

The bitstream is read by a variable length decoder. The variable length decoder decodes lossless codes encoding the video data. As noted above, the slice groups are losslessly encoded independent with respect to each other, however, the symbols within a slice group are encoded dependent on each other. Accordingly, the variable length decoder decodes the video data on a slice by slice basis.

The slices in the buffer do not necessarily begin and end at the boundaries of the data word. However, the memory controller fetches the video data at data word boundaries. As a result, when the memory controller fetches the data words storing a slice group, there is likely to be leading data before the slice group and trailing data following the slice group.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s), method(s), and apparatus for extracting slices from bitstream, substantially as shown in and/or described in connection with at least one of the figures, as set forth more completely in the claims.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing the coding of exemplary video data;

FIG. 2 is a block diagram of a video decoder in accordance with an embodiment of the present invention;

FIG. 3 is a block diagram of a variable length decoder in accordance with an embodiment of the present invention; and

FIG. 4 is a flow diagram for extracting slices from the bit stream in accordance with an embodiment of the present invention.

### DETAILED DESCRIPTION OF THE INVENTION

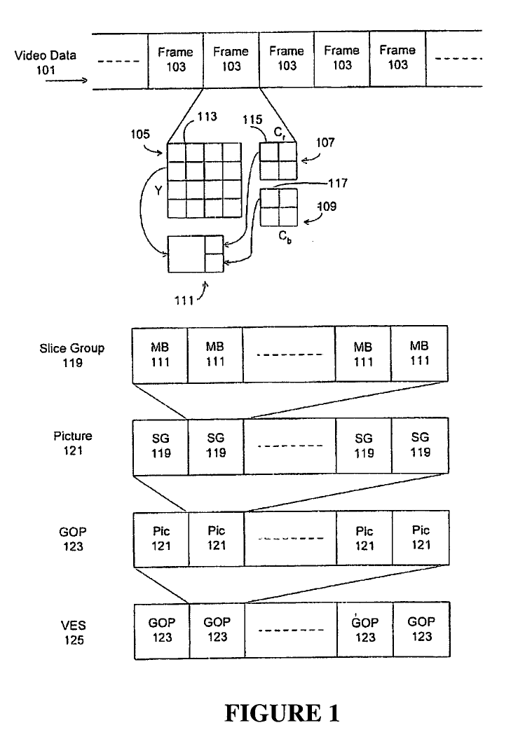

FIG. 1 illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cr, 107, and chrominance blue C_{b}, 109, pixels. The two-dimensional grids are divided into 8×8 blocks, where a group of four blocks or a 16×16 block 113 of luminance pixels Y is associated with a block 115 of chrominance red Cᵣ, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 103 (reference frames). When an appropriate (most similar, i.e. containing the same object(s)) portion of a reference frame 103 is found, the differences between the portion of the reference frame 103 and the macroblock 111 are encoded. The location of the portion in the reference frame 103 is recorded as a motion vector. The encoded difference and the motion vector form part of the data structure encoding the macroblock 111. In the MPEG-2 standard, the macroblocks 111 from one frame 103 (a predicted frame) are limited to prediction from portions of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

The pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence.

The VES 125 is coded using lossless coding, such as variable length coding. The variable length coding uses variable length codes to code data. The variable length codes are generally interdependent with respect to one another. Accordingly, the decoding of a variable length code is dependent on a previously decoded variable length code.

In the case of transmission errors brought on by noise during transmission of the VES 125, a variable length code can be corrupted. Although error detecting and correcting codes are used, enough errors can corrupt a variable length code. A corrupted variable length code can potentially propagate itself, causing errors in decoding other variable length codes that are dependent on the corrupted variable length code. To limit how far a corrupted variable length code can propagate, the variable length coding for each slice group is independent with respect to other slice groups. Thus, corrupted variable length codes in one slice group are prevented for propagating errors in another slice group.

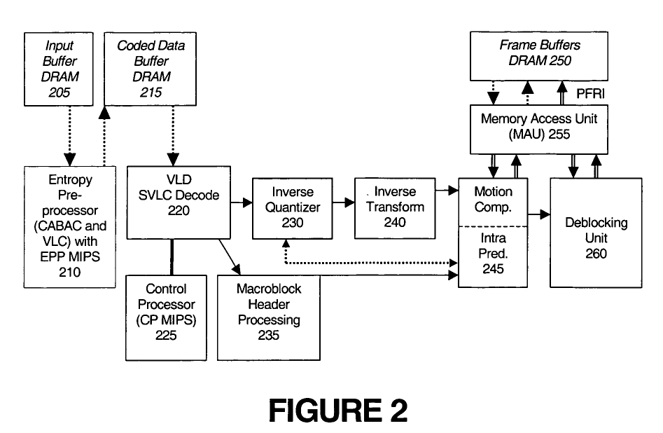

Referring now to FIG. 2, there is illustrated a block diagram describing an exemplary video decoder system 200 in accordance with an embodiment of the present invention. The video decoder 200 comprises an input buffer DRAM 205, an entropy pre-processor 210, a coded data buffer DRAM 215, a variable length code decoder 220, a control processor 225, an inverse quantizer 230, a macroblock header processor 235, an inverse transformer 240, a motion compensator and intra picture predictor 245, frame buffers 250, a memory access unit 255, and a deblocker 260.

The input buffer DRAM 205, entropy pre-processor 210, coded data buffer DRAM 215, and variable length code decoder 220 together decode the variable length coding associated with the video data, resulting in pictures 100 represented by macroblocks 111.

The inverse quantizer 230 inverse quantizes the macroblocks 111, resulting in sets of frequency coefficients. The macroblock header processor 235 examines side information, such as parameters that are encoded with the macroblocks 111. The inverse transformer 240 transforms the frequency coefficients, thereby resulting in a prediction error. The motion compensator and intrapicture predictor 245 decode the macroblock 111 pixels from the prediction error. The decoded macroblocks 111 are stored in frame buffers 250 using the memory access unit 255. A deblocker 260 is used to deblock adjacent macroblocks 111.

The coded data buffer DRAM 215 stores the encoded video data for the variable length decoder. According to certain embodiments, the coded data buffer DRAM 215 stores the encoded video data as 256-bit/32 byte data words, known as Jumbo words (Jwords).

As noted above, the variable length codes are data dependent with respect to each other within a slice group 119. However, the variable length coding for each slice group 119 is independent with respect to other slice groups 119. Accordingly, variable length decoder 220 decodes the slice groups 119 on a slice-by-slice basis. However, the slice groups 119 do not necessarily start or end on Jword boundaries in the coded data buffer DRAM 215.

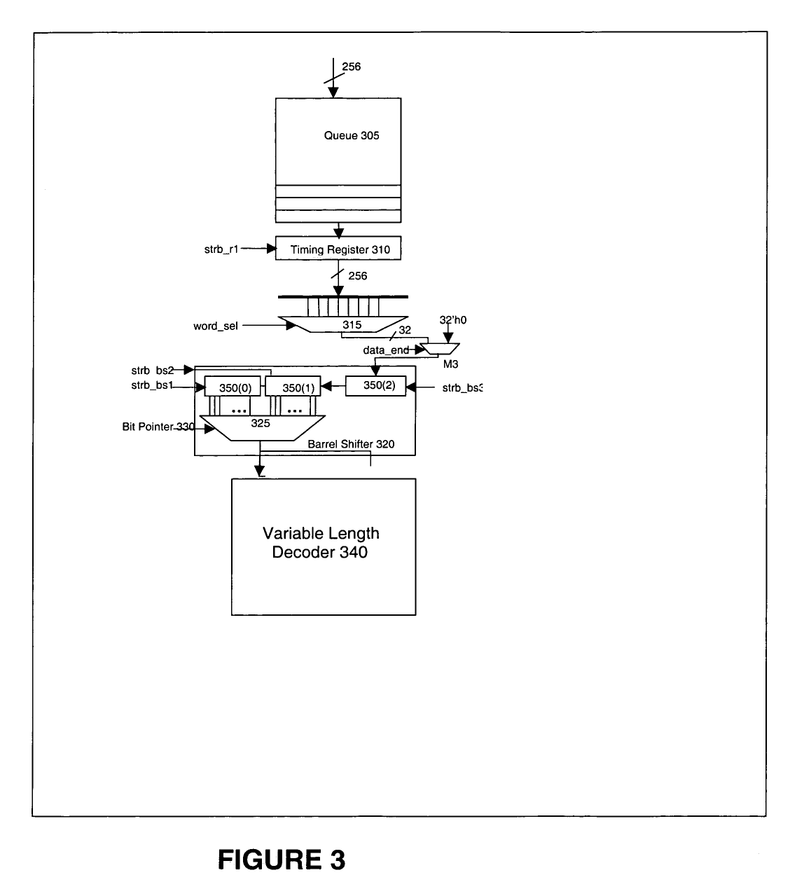

Referring now to FIG. 3, there is illustrated a block diagram of an exemplary variable length decoder 220 in accordance with an embodiment of the present invention. The variable length decoder 220 comprises a queue 305, a timing register 310, multiplexer 315, multiplexer 320, a barrel shifter 325, a bit pointer 330, logic 335, and a variable length code decoder 340.

The queue 305 receives and stores the video data as sequential data words. According to certain aspects of the present invention, the data words can comprise Jwords. A timing register 310 provides data words to the multiplexer 315.

The multiplexer 315 divides the data words into smaller data words. According to certain aspects of the present invention, the smaller data words can comprise 32 bits. The multiplexer 315 is a 256:32 multiplexer. The particular 32 bits selected by the multiplexer are determined by word select control signal word_sel. By incrementing the word select signal, the multiplexer 315 provides a sequence of smaller data words forming the data word.

The barrel shifter 325 receives the sequence of smaller data words. The barrel shifter 325 includes shift registers 350(0), 350(1), and 350(2y). The barrel shifter shifts the contents therein from shift register 350(2), to register 350(1), to register 350(0).

The multiplexer 320 provides one or more bits at a time from the register 350(0) and register 350(1) to the variable length code decoder 340. As each of the one or more bits is provided by multiplexer 320 to the variable length code decoder 340, logic 335 increments the bit pointer 330 to point to the next bit.

Initially, at the start of a slice group, the controller 225 sets the word select signal word_sel and bit pointer 330 to point to the smaller data word and starting byte where the slice group begins. This avoids consumption of trailing bytes, where the slice group starts within a data word.

When the bit pointer 330 points to a bit in register 350(1), the contents of register 350(1) are shifted to register 350(0), and the contents of register 350(2) are shifted to register 350(1). The multiplexer 315 provides the next smaller data word to the shift register 350(2), and the word select signal word_sel is incremented.

Where the word select signal word_sel has pointed to the last smaller data word forming the data word received by the multiplexer 315, the timing register 310 provides the next data word form the queue 305 to the multiplexer 315 and the word select signal word_sel is reset.

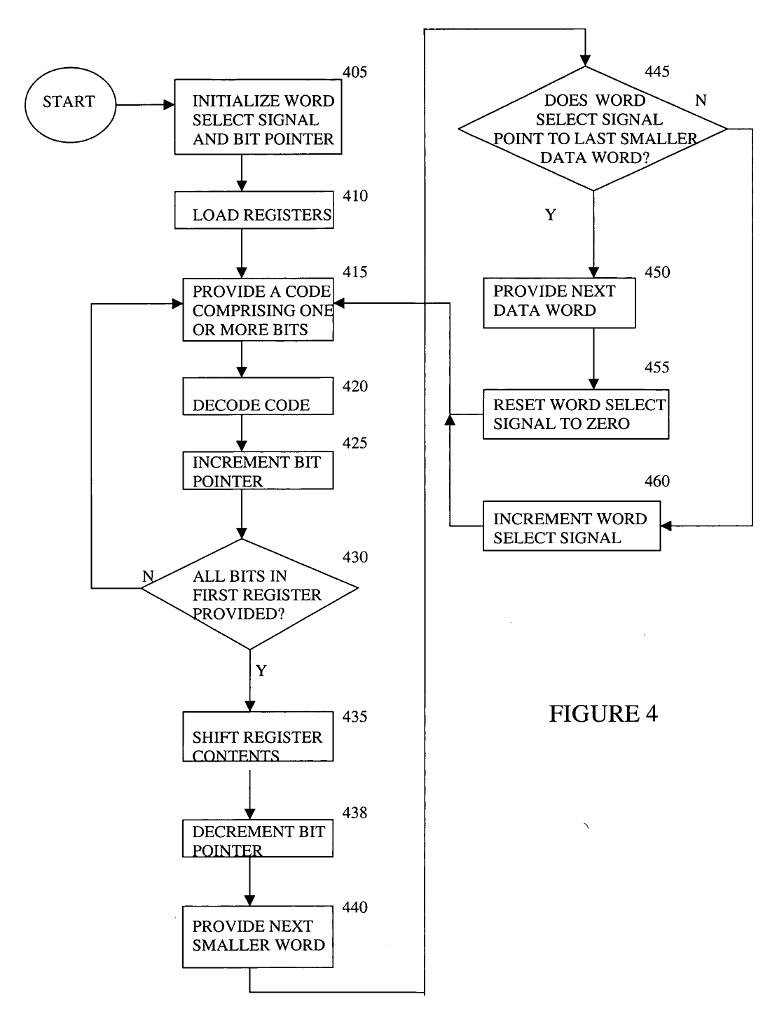

Referring now to FIG. 4, there is illustrated a block diagram for extracting a slice group from a plurality of data words. At 405, the controller 225 initializes the word select signal word_sel and the bit pointer 330 to point to the smaller data word and the starting byte within the Jword.

At 410, the multiplexer 315 loads the registers 350(2), 350(1), and 350(0). At 415, the multiplexer 320 provides a code comprising one or more bits to the variable length code decoder 340 to decode at 420. At 425, the logic 335 increments the bit pointer 330 increments to point to the next bit following the one or more bits provided during 415.

If at 430 the bit pointer 330 points to a bit that is in register 350(1), i.e., all of the bits of register 350(0) are provided to the variable length code decoder, the contents of the register 350(1) are shifted to register 350(0), and the contents of register 350(2) are provided to the register 350(1) at 435. The logic decrements the bit pointer 330 at 438. At 440, the multiplexer 315 provides the next smaller data word forming a portion of the data word.

If at 445, the word select signal word_sel points to the last smaller data word forming a portion of the data word, at 450, the timing register 310 provides the next data word to the multiplexer 315 at 455 and the word select signal word_sel is reset to zero. If at 445, the word select signal word_sel does not point to the last smaller data word forming a portion of the data word, 450 and 455 are bypassed and the word select signal word_sel is incremented at 460. In either case, 415 is then repeated.

If at 430 the bit pointer 330 points to a bit in register 350(0), 435-460 are bypassed and 415 is repeated.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor. In one representative embodiment, the encoder or decoder can be implemented as a single integrated circuit (i.e., a single chip design).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. For example, although the embodiments have been described with a particular emphasis on the MPEG-2 standard, the teachings of the present invention can be applied to many other standards without departing from it scope. Therefore, it is intended that the present invention not be limited to the particular embodiment disclosed, but that the present invention will include all embodiments falling within the scope of the appended claims.

1. A circuit for extracting a data structure from one or more data words, said circuit comprising:
a multiplexer for dividing the one or more data words into a plurality of smaller data words;
a barrel shifter for shifting the smaller data words;
another multiplexer for providing one or more bits from one or more of the smaller data words; and
a bit pointer for pointing to a bit following the provided one or more bits in the one or more of the smaller data words.

2. The circuit of claim 1, further comprising a variable length decoder for decoding the one or more bits.

3. The circuit of claim 1, wherein the data words comprise 256 bits and the smaller data words comprise 32 bits.

4. The circuit of claim 1, further comprising:
logic for incrementing the bit pointer to point to the bit following the provided one or more bits in the one or more of the smaller data word

5. The circuit of claim 1, further comprising:
a controller for initializing the bit pointer to point to a particular bit, said particular bit being the start of the data structure.

6. The circuit of claim 1, further comprising a queue for sequentially storing the one or more data words.

7. The circuit of claim 6, further comprising:
a timing register for providing the one or more data words to the multiplexer.

8. The circuit of claim 1, wherein the barrel shifter further comprises:
a first shift register for storing a first one of the one or more smaller data words;
a second shift register for storing a second one of the one or more smaller data words; and
wherein the second shift register shifts out the second one of the one or more smaller data words to the first shifter register, after the multiplexer provides each bit of the first one of the one or smaller data words.

9. The circuit of claim 8, further comprising:
a third shift register for storing a third one of the one or more smaller data words.

10. A method for extracting a data structure from one or more data words, said method comprising:
dividing the one or more data words into a plurality of smaller data words;
shifting the smaller data words;
providing one or more bits from one or more of the smaller data words; and
pointing to a bit following the provided one or more bits in the one or more of the smaller data words.

11. The method of claim 10, further comprising:
decoding the one or more bits.

12. The method of claim 10, wherein the data words comprise 256 bits and the smaller data words comprise 32 bits.

13. The method of claim 10, further comprising:
incrementing the bit pointer to point to the bit following the provided one or more bits in the one or more of the smaller data words.

14. The method of claim 10, further comprising:
initializing the bit pointer to point to a particular bit, said particular bit being the start of the data structure.

15. The method of claim 10, further comprising:
sequentially storing the one or more data words.

16. The method of claim 10, further comprising:
storing a first one of the one or more smaller data words;
storing a second one of the one or more smaller data words; and
shifting out the second one of the one or more smaller data words; and
overwriting the first one of the one or more smaller data words after providing each bit of the first one of the one or smaller data words.

17. The method of claim 16, further comprising:
storing a third one of the one or more smaller data words.
